(19) United States
(12) Patent Application Publication
(10) Pub. No.: US 2005/0168818 A1
(43) Pub. Date: Aug. 4, 2005

(54) Portable reusable emergency safety device

(76) Inventor: Edward C. Hudson JR., Putnam, CT (US)

Correspondence Address: Thomas E. Hagar, 129 Boston Post Road, Wayland, MA, 01778, US

(21) Appl. No.: 10/768,219

(22) Filed: Jan. 30, 2004

(51) Int. Cl. G02B 5/12

(52) U.S. Cl. 359/515; 359/553

(57) ABSTRACT

The present invention is an inexpensive safety tape that can be used in several applications including, but not limited to, the illumination of a disable vehicle on the side of a roadway. The invention consists of few moving parts including a housing, reflective tape and a connecting device that allows the tape to be connected to an object for demarcation. When used with a disable car on the side of a roadway the reflective tape is connected to the vehicle and then deployed behind the vehicle in such a manner that it provides an early warning system to oncoming traffic. Alternatively, the invention can be used with a stand that allows the reflective tape to be used as a temporary barrier or a demarcation device to cord off a given area.

### BACKGROUND

a) Field of the Invention

This invention relates to the field of safety devices for improving the visibility of a parked, stranded or disable vehicle, or other obstruction at day or night. The invention also relates to the field of demarcating or cording off a given area for safety or other reasons.

b) Description of the Related Art

The present invention is directed towards safety devices designed to improve the visibility of an obstruction on the side of a roadway and, more specifically, a disable vehicle in the breakdown lane of a roadway. One of the main problems encountered with obstructions or disable vehicles on the side of the roadway is visibility. Specifically, the ability of an oncoming motorists to sufficiently observe an obstruction or disable vehicle in sufficient time to determine the location of the obstruction or disable vehicle and take steps to avoid the same if necessary. There are a number of different methods to achieve the task of providing an early warning system to oncoming motorists that they are approaching a potential hazard in, or just off, the roadway. Among the methods are flares, reflective safety stickers that adhere to the side of the obstruction, reflective devices permanently attached to the obstruction, safety strips or belts, safety tape that is designed to rap around the obstruction, etc. However, none of these methods are as effective or efficient as the present invention in providing an early warning system to oncoming motorists.

Flares can be expensive, are only a single use device and when spread out on the roadway do not provide a continuous line of reflection as the present invention's reflective tape. Safety stickers or belts that attach or adhere to the disable vehicle, or obstruction, are small, difficult to see from a distance and as they are only attached directly to the vehicle do not provide an extra warning as the present invention does by being deployed several feet behind the vehicle. Safety devices that are permanently attached to the vehicle suffer from these same problems. In addition, these devices have the negative effect of being permanently attached to the vehicle thereby taking away some of the aesthetics of the exterior of the vehicle. On the contrary, the present invention is only used temporarily and thus is not a permanent fixture on the vehicle.

Reflective tapes that are designed to rap around the car suffered from the same above mentioned shortcomings as other devices that are designed to attach to the vehicle only. Also, these tapes are dangerous for the motorist to attach to the vehicle, as one needs to walk around the vehicle to apply the tape thereby requiring the motorist to walk into the travel lane on one side of the car and on the shoulder of the road on the other side of the vehicle. Consequently, the motorist runs the risk of being in the travel lane where there is oncoming traffic and the risk of walking on the unpaved shoulder of the road or highway which is not always the safest or level ground to walk on. The present invention overcomes the shortcomings of the prior art as it is designed to be temporary and deployed behind the vehicle or obstruction.

### SUMMARY OF THE INVENTION

The present invention is a simple yet ingenuous design with few moving parts. The invention consists of mechanically connected reflective means with the preferred embodiment being a reflective tape. Alternative to tape, a lined device such as, but not limited to, a chain, cable, rope or other device that performs the same function could be used. The reflective tape is contained inside a housing. One end of the reflective tape is anchored inside of the housing while the other end of the reflective tape can be attached to a uniquely designed bracket that allows it to be connected to the obstruction or vehicle. Alternatively, the outer end of the reflective tape can contain a loop portion that may be used in conjunction with stands to demark a given area. When the invention is deployed in conjunction with a disable vehicle, or other obstruction, the reflective tape is first affixed to a vehicle, or other obstruction, and then it is deployed behind the vehicle. In the case of a disable vehicle in a breakdown lane of a roadway, the reflective tape is first attached to the vehicle and then is deployed behind the vehicle by the motorist walking away from the car while staying inside the safety of the breakdown lane. Once the reflective tape is fully deployed the housing is placed on the road surface and acts as an anchor to provide sufficient tightness to the reflective tape so that its movement is limited. Alternatively, the housing could be anchored to the car and reflective tape attached to a weighted device that is placed behind the car.

Once deployed the invention provides the benefit of being a continuous warning signal starting from a distance behind the disable vehicle to the vehicle itself. Consequently, oncoming motorist will have an early warning signal and also be able to track the signal (i.e. the reflective tape) directly to the disable vehicle ensuring that the motorist will be on notice of the direct location of the disable vehicle and be in a position to take steps to avoid the same. All of this is shown in FIG. 1.

Therefore, the invention overcomes the shortcomings of safety devices that only attach to the vehicle itself. Also, as the reflective tape provides a single and continuous signal to the disable vehicle it overcomes the shortcoming of flares that are only dispersed individually along the roadway. In addition, the reflective tape allows the obstruction to be more visible rather than hidden behind the glare created by the flares. Lastly, the deployment of the invention provides the disable motorist with the safety of walking in the breakdown lane as opposed to the risk of entering the travel lane or the unpaved shoulder of the roadway.

If needed the invention can be used in conjunction with any other obstruction on the side of a roadway. Also, it can be used in conjunction with stands to act as a temporary barrier or a demarcation device to cord off a given area.

Accordingly, one object of this invention is to provide an inexpensive safety device that can be used in conjunction with disabled vehicles on the side of a roadway.

Another object of this invention is to provide a safety device that can be safety deployed by a disabled motorist.

A third object of this invention is to provide a device that can be used to safety mark off an obstruction on, or on the side, of a roadway.

A fourth object of this invention is to provide a safety device that can be easily stored and reused.

A fifth object of this invention is to provide a safety device that can also be used in other applications such as, but not limited to, a temporary barrier or a demarcation device to cord off a given area.

Other objects and advantages of this invention will become apparent from the following detailed description taken in conjunction with the accompanying drawings.

### BRIEF DESCRIPTION OF THE DRAWINGS

These and other features, aspects and advantages of the present invention will become better understood with reference to the following description, appended claims, and accompanying drawings where,

FIG. 1 is a perspective view of the invention in its deployed position,

FIG. 2 is a perspective view of the invention,

FIG. 3 is a perspective view of the bracket,

FIG. 4 is a perspective view of the invention deployed with stands,

FIG. 5 is a perspective view of the stand connector,

FIG. 6 is a perspective view of the invention connected to a stand connecter,

FIG. 7 is a plan view of the invention,

FIG. 8 is a perspective view of the stand connector,

FIG. 9 is a cut away view of the interior of the housing.

### DETAILED DESCRIPTION OF THE PREFERRED EMBODIMENT

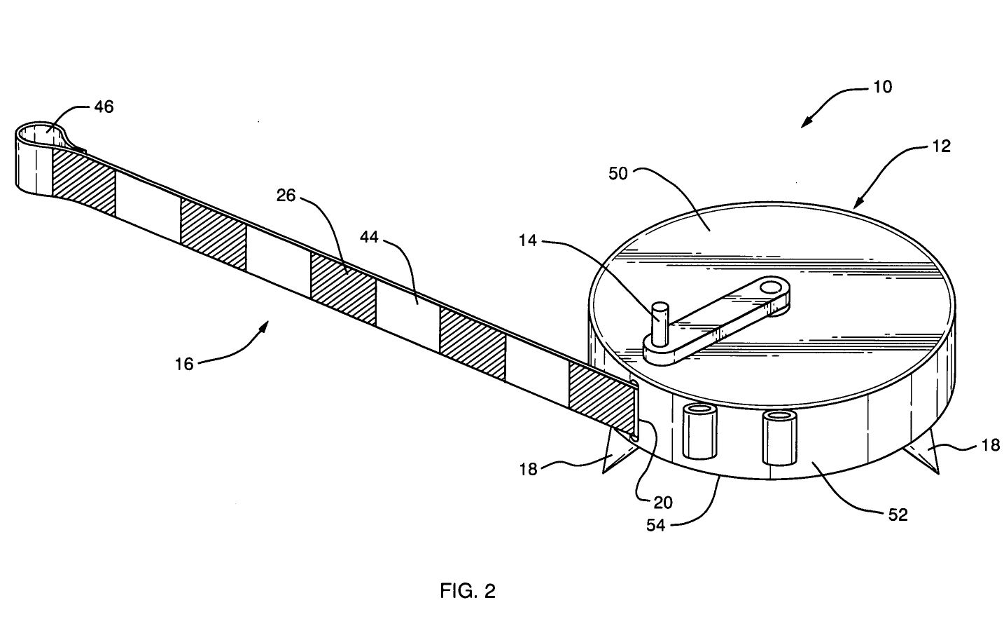

Referring to the Figures and more specifically FIG. 2, the invention 10 consists of a generally cylindrical housing 12, a deployment means, supporting retractable feet 18 and mechanically connected reflective means. The mechanically connected reflective means could be any line device such as, but not limited to a tape, chain, cable, rope or other device that performs the same function with the preferred embodiment being a reflective tape 16. The deployment means could be by different methods such as, but not limited to, a hand crank, spring actuated deployment means similar in design to one used for electrical cords of vacuum cleaners or a spring actuate means used in common tape measures. The preferred embodiment of the deployment means is a hand crank 14.

The housing 12 consists of a top portion 50, a side portion 52 and a bottom portion 54. The top portion 50 and bottom portion 54 are essentially flat planes that are parallel to each other. The side portion 52 is cylindrical in shape thereby giving the general overall shape of the housing 12. The side portion 52 is also a means to connect the top portion 50 to the bottom portion 54. An open slot 20 is disposed in the side portion 52 and is of sufficient size to provide a means to allow the reflective tape 16 to enter and exit the housing 12. The open slot 20 should not be so large as to let dirt and debris into the housing 12 or onto the reflective tape 16 when the same is deployed in and out of the housing 12. The open slot 20 is oriented in such a way that it runs perpendicular to both the top portion 50 and the bottom portion 54. The open slot 20 also provides a means to keep the reflective tape 16 clean.

The hand crank 14 is disposed in the middle of top portion 50 and runs through the interior of the housing 12 parallel to the side portion 52 and is connected to the bottom portion 54 of the housing 12 (See FIG. 9, internal view of housing). The hand crank 14 is connected to the housing 12 in a manner that is similar to a hand crank in a common tape measure. When the invention 10 is not in use the reflective tape 16 is disposed within the housing 12. The hand crank 14 provides a means to retract the reflective tape 16 into the housing 12. Alternative to the hand crank 14 a deployment means could be used to deploy the reflective tape 16 from the housing 12 and return the reflective tape 16 to the housing 12. A number of different methods could be used to create the deployment means. A few examples, but not limited to, are a spring actuated deployment means similar in design to one used for electrical cords of vacuum cleaners or a spring actuate means used in common tape measures.

The feet 18 are connected to the bottom portion 54 of the housing 12 and provide a means to rest the invention 10 on a given surface when the invention 10 is in use. A number of feet 18 may be used with the preferred embodiment being three. The feet 18 have sharp points so that they may grip the surface that the invention 10 is placed on. When the invention 10 is not in use the feet 18 are designed to fold under the invention 10 for easy storage.

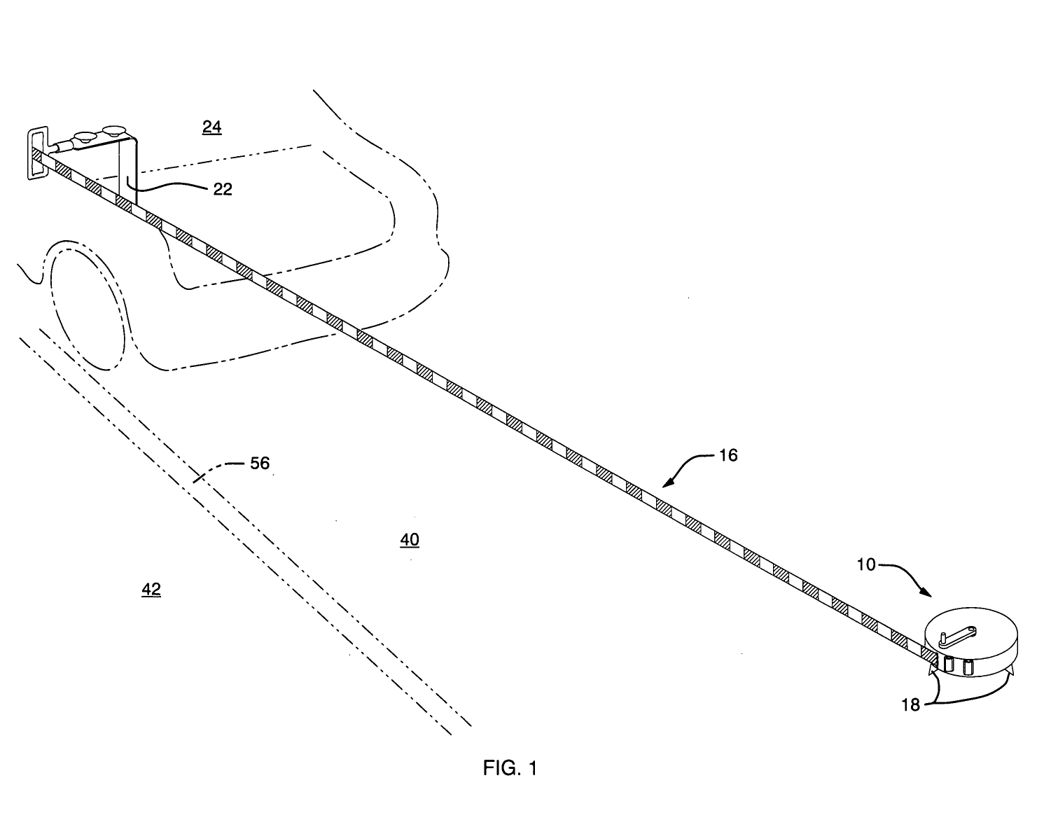

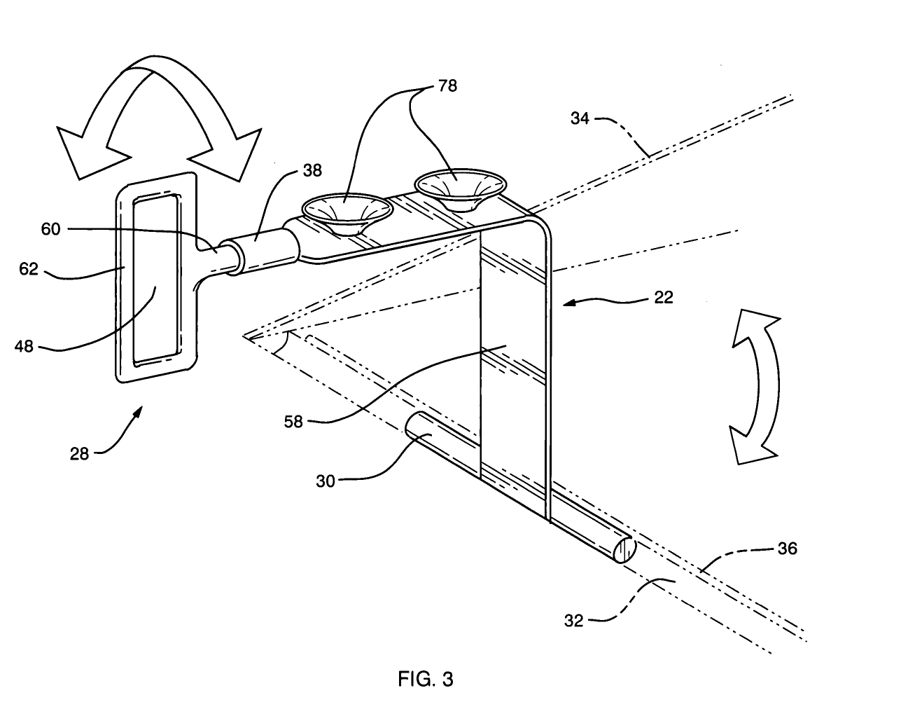

The reflective tape 16 has a plurality of different reflective colors with the preferred embodiment being two. The reflective tape 16 has a reflective portion 26 of one color and a reflective portion 44 of another color. As an example of one embodiment, the reflective tape 16 can be made out of any common material used for tape with the preferred embodiment being a flexible plastic or other cost effective material. The reflective tape 16 should however be made from material with sufficient strength to withstand the distance that it is deployed without breaking or sagging excessively during use (See FIG. 1). The reflective portions 26 and 44 can be made from any common reflective material with the preferred embodiment being cost effective and practical. The reflective material may be applied to the tape in any manner that is common to the tape industry. One end of the reflective tape 16 is connected to the portion of the hand crank 14 that is disposed within of the housing 12 in a manner similar to that of a common tape measure. The other end of the reflective tape, the exterior end loop 46, is outside of the housing 12 and can be connected and/or anchored to any device necessary to use the invention 10. When the invention 10 is used in conjunction with an obstruction on a roadway, the preferred embodiment of the invention 10 has the end loop 46 permanently fixed to the eyelet loop 62 of the bracket 22 (see FIG. 3). When the invention 10 is used in conjunction with free stands, the preferred embodiment of the invention 10 has the end loop 46 free allowing it to be placed over the peg 84 as seen in FIG. 8.0.

FIG. 1 displays one example of the invention 10 in its deployed position when it is used in conjunction with day and night visibility marking a stationary obstruction close to the path of moving vehicle, in this case a disable vehicle on the side of a roadway. The disabled car 24 is parked in the breakdown lane 40 that is adjacent to the travel lane 42. A line 56 that is generally white in color separates the travel lane 42 and the breakdown lane 40. The travel lane 42 could be a major highway or an ordinary country road. In this application the invention 10 is deployed by first connecting the bracket 22 to the vehicle 24 (See FIG. 3), or other obstruction as the case may be, so that the invention 10 can give warning to travelers traveling in the travel lane 42. The bracket 22 is immobilized once it is attached to the vehicle 24. The reflective tape 16 is then deployed from the vehicle 24 a given distance by unwinding the tape from the housing 12. Once the given distance is achieved the reflective tape 16 is pulled to a sufficient tightness, the feet 18 are deployed, and the invention 10 is rested on the road surface. The housing 12 is of sufficient weight such that its combination with bracket 22 being anchored to the vehicle 24 provides a means to maintain the tightness of the reflective tape 16. Alternatively, the housing 12 can be attached to the bracket 22 and the end loop 46 is attached to a weighted device that is deployed behind the vehicle. If the housing 12 is used in this manner it need not be weighted. The combination of the housing 12 and the bracket 22 also provide a means to keep the reflective tape 16 elevated off the ground.

The reflective tape 16 is designed to deploy within the breakdown lane 40. The reflective tape 16 it placed on the travel lane side of the vehicle 24, or obstruction, and then deployed behind the vehicle 24 in the direction of the oncoming traffic. The housing 12 is placed on the ground in the breakdown lane 40 behind the vehicle 24. The housing 12 is placed at a greater distance from the breakdown lane line 56 than the bracket 22 such that the reflective tape 16 is not parallel to the breakdown lane line 56 but creates an angle running across the breakdown lane. Once the reflective tape 16 is deployed as in FIG. 1 it can be seen from motorists driving in the travel lane 42 and approaching the disable vehicle 24. At dusk or nighttime an oncoming car's headlights will illuminate the reflective tape 16 to act as an early warning that there is a broken down vehicle, or other obstruction, in the breakdown lane 40. During the daytime the reflective tape 16 will act as an additional warning system with its highly visible characteristics.

FIG. 3 displays the bracket 22 and how it is attached to a car. The bracket 22 consists of main portion 58, a collar 38, an eyelet loop 28 and a connecting device 30. The eyelet loop 28 consists of a stem 60 and a loop portion 62. The loop portion 62 creates a loop opening 48. The collar 38 provides a means to connect the eyelet loop 28 to the main portion 58. The eyelet loop 28 provides a means of connecting the reflective tape 16 to the bracket 22. The stem 60 of the eyelet loop 28 is disposed within the collar 38 and is affixed in a way so as to allow the eyelet loop 28 to spin freely within the collar 38. The main portion 58, the collar 38 and the loop eyelet 28 can be made of any sturdy material with the preferred embodiment being a metal or fiberglass material. The main portion 58 is bent at an angle with the preferred embodiment being a 90-degree bend. The main portion 58 is sufficiently long enough to allow the bracket 22 to be connected to the car while maintaining the reflective tape 16 a safe distance from the car to prevent the same from rubbing on the car. The connecting device 30 is affixed to the base of the main portion 58.

The connecting device 30 is designed to secure the bracket 22 to the car. The connecting device 30 is designed to fit in the trunk, or rear opening, door jam of the car. The trunk door jam is that area that is created when one closes the trunk door 34 onto the rubber trunk gasket 36 of the trunk. The closing of the trunk door 34 onto the connecting device 30 and the rubber trunk gasket 36 secures the bracket 22 to the car. When the trunk door 34 is closed the connecting device 30 is dispose between the trunk door 34 and the rubber trunk gasket 36. The connecting device 30 is made from a soft material so as not to damage the trunk door 34 or the trunk gasket 36. The preferred embodiment is a pliable rubber material.

The connecting device 30 may also be used in conjunction with a van, caravan or pickup truck. In the case of a van or caravan the connective device 30 is placed in the jam created by the backdoor of the van or caravan. In the case of a pickup truck the connecting device can be placed in the jam created by the tailgate of the truck. Alternatively the bracket 22 may be secured to a disable vehicle, or other obstruction, using a number of attaching means. One such alternative attaching means, but not limited to this example, is the use of suctions cups 78. The suction cups 78 may be attached to the rear window of the vehicle or any other adequate smooth surface on the vehicle. With the case of another obstruction the suction cups are simply attached to any flat surface of the obstruction.

The movement of the eyelet 28 in the collar 38 is necessary for a proper deployment of the reflective tape 16. When the invention 10 is deployed it is generally level with the trunk lid 34, as one would generally deploy the invention at one's waist level. Once the invention 10 is placed on the ground its level drops thereby causing the eyelet loop 28 to rotate clockwise. This rotational movement of the eyelet loop 28 maintains the reflective tape 16 in a flat orientation without it binding or folding. If necessary the eyelet loop 28 allows the invention 10 to be deployed in a 360-degree arc around the bracket.

Once the emergency is over the invention 10 can be returned to its storage position. One simply picks up to the housing 12 off the ground and winds the reflective tape 16 back into the housing 12 using the hand crank 14. Once all the reflective tape 16 is disposed in the housing 12 one can remove the bracket 22 from the trunk door jam by simply opening the trunk door lid 34 and removing the bracket 22 from the door jam. The feet 18 are retracted under the housing 12 and the invention 10 is ready for storage.

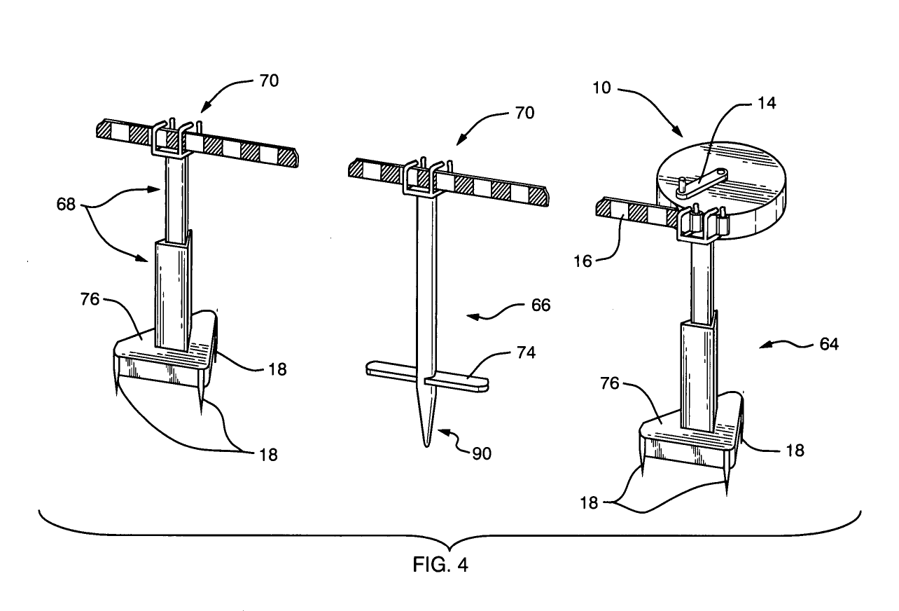

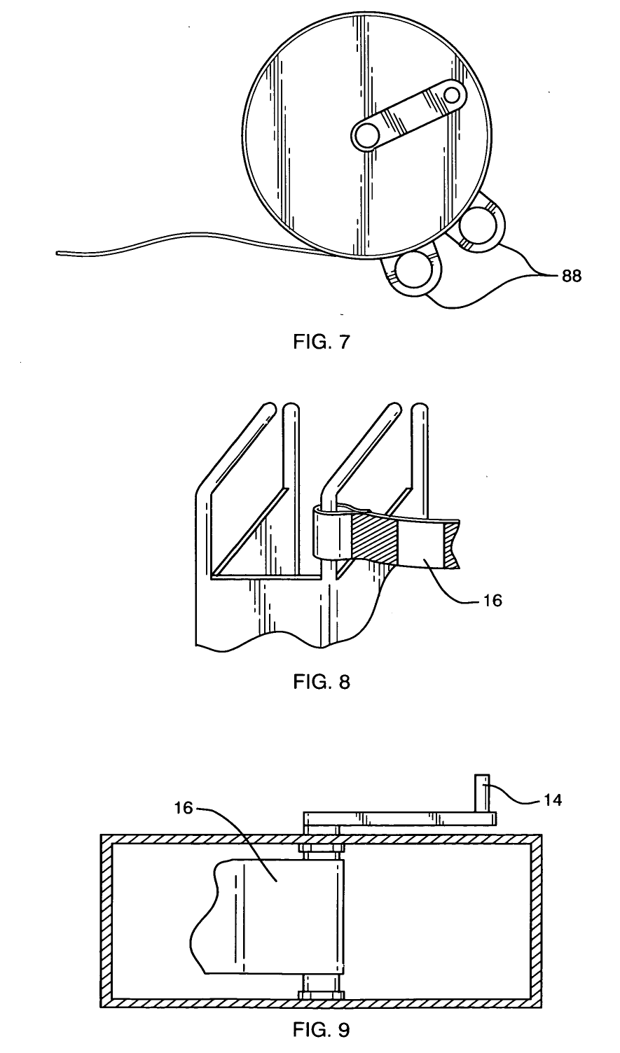

An alternative use for the invention 10 is in a deployment to enclose an area for various reasons such as a construction site or a police barricade. In referring to FIG. 4 through FIG. 8, the invention 10 is placed on stands that allow the reflective tape 16 to be elevated off the ground. There are two types of stands depending on the ground surface encountered. A self standing stand 64 can be used on a hard surface and has a weighted base 76 and pointed feet 18. The weighted base 76 provides a means to keep the stand vertical. On the other hand a soft material stand 66 may be used when soft material is encountered. The soft material stand 66 is simply placed into the soft ground by applying pressure to the foot pegs 74 causing the spike 90 to go into the ground. The spike 90 provides a means to keep the stand vertical. As the invention 10 will be used in conjunction with the stands 64 and 66 the housing 12 does not have to be weighted and the feet 18 do not have to be present on the bottom of the housing 12. Instead the feet 18 are place on the base 76 of the stand 64. In the case of the self standing stand 64 no feet are necessary.

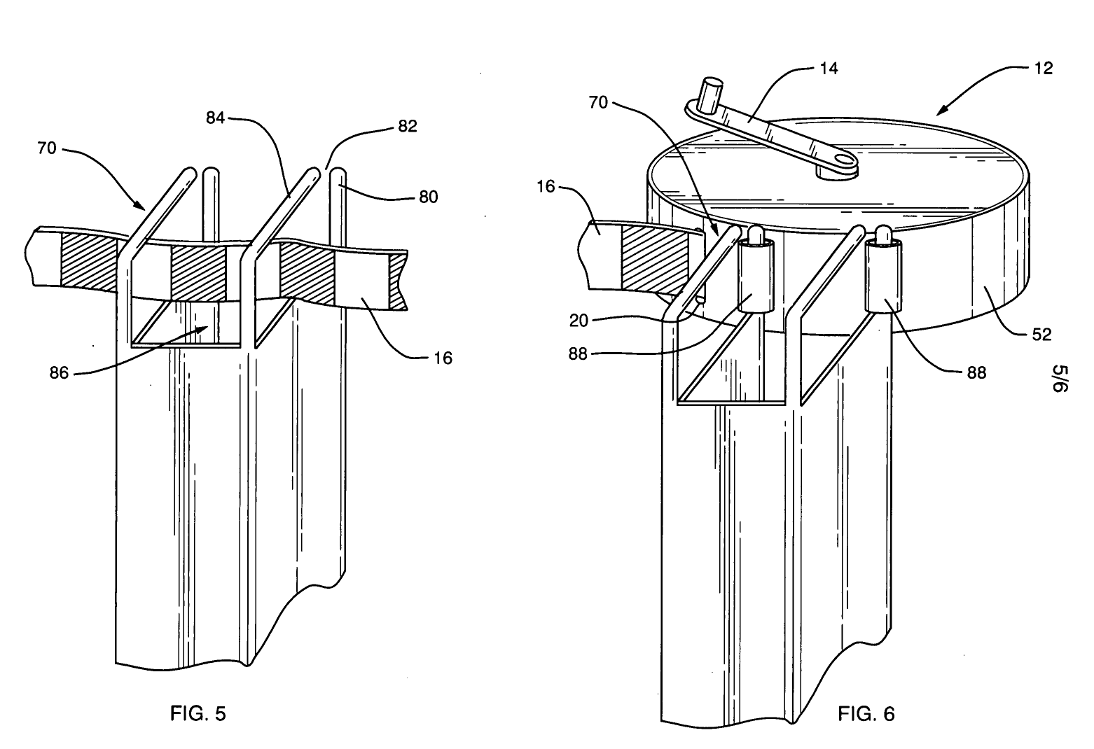

One will deploy the reflective tape 16 in the same manner as the car version but one will used the stands to hold the reflective tape 16 in position. Each stand has a tape connector 70 that accepts that exterior end loop 46 of the reflective tape 16 and provides a means to affix the reflective tape 16 to a given stand (see FIG. 5 and FIG. 6). The tape connector 70 consists of a plurality of pegs 80 with the preferred embodiment being four. The pegs 80 provide a means to secure both the reflective tape 16 and housing 12 to the tape connector 70. In the preferred embodiment there is a return 84 that is in a 90-degree relation to the main portion of the two of the pegs 80. The return 84 of a given peg 80 is in orientation with another peg 80 such that a gap 82 is created. All of the legs together create a cavity 86 designed to accept the reflective tape 16 and to secure the same to the stand. The width of the gap 82 is only slightly larger that the thickness of the reflective tape 16 thereby allowing the tape to be deployed within the cavity 86 but preventing the same from easily leaving the cavity 86 (see FIG. 5).

FIG. 6 through FIG. 8 show how the housing 12 and the end of the reflective tape 16 are attached to the stands. The housing 12 has two channels 88 attached to the side of the housing 52. The inner diameter of the channel 88 is greater that the outer diameter of the peg 80 of the stand. The housing 12 is connected to the stand by placing it on the stand such that the pegs 80, not containing the returns 84, are disposed within the channels 88 (See FIG. 6). The channels 88 come to a rest at the base of the pegs 80 and the housing 12 is thus secured to the stand. The exterior end loop 46 of the reflective tape 16 is attached to the stand by simply placing it over the peg 80 that has the return 84 (See FIG. 8).

If more tape is needed one may utilize a second invention. This is done by attaching exterior end loop 46 of the second reflective tape 16 to the stand 66, or 64, where the previous housing 12 is affixed, and by sliding the end loop 46 the peg 80 that has the return 84 as shown in FIG. 8. This allows a plurality of reflective tapes 16 to be chained together to mark off a large space.

1) A Portable Reusable Emergency Safety Device comprising:
a housing having a top portion, bottom portion and a side portion, where the top and bottom portion are in parallel to each other and the side portion provides a means to connect the top portion to the bottom portion;
where the side portion contains a slot that runs perpendicular to both top and bottom portions;
a deployment means disposed in the center of the housing and orientated perpendicular to both the top and bottom portions and connected to the same;
a mechanically connected reflective means with two ends, an outer end and an inner end, with the inner end disposed within the housing and attached to the deployment means disposed therein;
where the slot provides a means to allow the outer end of the mechanically connected reflective means to be deployed outside of the housing; and provides a means to keep the same clean and free of abrasion;
where the outer end of the mechanically connected reflective means contains a connecting loop portion that may be used to secure the same to an object or suitable mechanism.

2) A Portable Reusable Emergency Safety Device as in claim 1 where the connecting loop portion of the mechanically connected reflective means is affixed to a bracket having an eyelet loop portion and having an attaching means suitable to affixed the bracket to a vehicle or obstruction; where the connecting loop portion of the outer end of the mechanically connected reflective means is affixed to the eyelet loop of the bracket.

3) A Portable Reusable Emergency Safety Device as in claim 1 where the connecting loop portion of the mechanically connected reflective means is affixed to a bracket having an eyelet loop portion and having a plurality of suction cups to affixed the bracket to a vehicle or obstruction; where the connecting loop portion of the outer end of the mechanically connected reflective means is affixed to the eyelet loop of the bracket.

4) A Portable Reusable Emergency Safety Device as in claim 1 where the invention is used in conjunction with a free standing stand having a means to be held vertical and having a means to affix both the connecting loop portion of the mechanically connected reflective means and the housing to the stand.

5) A Portable Reusable Emergency Safety Device as in claim 1 where the invention is used in conjunction with a free standing stand having a means to be held vertical and having a plurality of pegs to affix both the connecting loop portion of the mechanically connected reflective means and the housing to the stand.

6) A Portable Reusable Emergency Safety Device as in claim 1 where the mechanically connected reflective means contains a plurality of reflective colors.

7) A Portable Reusable Emergency Safety Device as in claim 1 where the mechanically connected reflective means contains a two different reflective colors.

8) A Portable Reusable Emergency Safety Device as in claim 1 where the mechanically connected reflective means consists of a lined device such as, but not limited to, a tape, chain, cable, rope or other device that performs the same function.

9) A Portable Reusable Emergency Safety Device as in claim 1 where the housing can be attached to the vehicle or obstruction and the connecting loop of the mechanically connected reflective means is attached to a weighted device.

10) A Portable Reusable Emergency Safety Device as in claim 1 where the housing is weighted and the where the combination of the weighted housing and the connection to the vehicle or obstruction provides a means to maintain the mechanically connected reflective means elevated off the ground and taut.

11) A Portable Reusable Emergency Safety Device as in claim 1 where the mechanically connected reflective means is designed to be deployed in conjunction with a vehicle or obstruction adjacent to a right of way.

12) A Portable Reusable Emergency Safety Device as in claim 1 where the deployment means is spring actuated or hand operated.
